(19) United States
(12) Patent Application Publication
(10) Pub. No.: US 2020/0333151 A1
(43) Pub. Date: Oct. 22, 2020

(54) Charge Sharing and Smart Charging Infrastructure Integration for Electric Vehicles

(71) Applicant: Sabrina Akhtar, Palo Alto, CA (US)

(72) Inventor: Sabrina Akhtar, Palo Alto, CA (US)

(21) Appl. No.: 16/230,362

(22) Filed: Dec. 21, 2018

Related U.S. Application Data
(60) Provisional application No. 62/609,283, filed on Dec. 21, 2017.

(51) Int. Cl. G01C 21/34; B60L 53/64

(52) U.S. Cl. CPC G01C 21/3469; B60L 58/12; B60L 53/64

(57) ABSTRACT

A system for Peer to Peer Charge Sharing and Smart Electric Vehicle Charging Infrastructure Integration using Internet of Things (IoT) are disclosed. It utilizes an on demand EV charging model with a mobile app to locate nearest available charging for users through GPS, sms text messaging notification to confirm booking in real time. A new way of automatic location finder was also described, for example, when the charging unit is integrated by IoT where sensors are embedded in the charging unit with mounted micro-controller board to send signal via mesh network WiFi or mesh network Blutooth or GPS to cloud. This signal is also sent to the Electric Vehicle's WiFi network to automatically find the charge location which interacts with the vehicle's battery unit. So when the battery's charge amount is low and reaches a certain threshold, the signal is sent out to locate nearby available charging unit.

The availability of nearest charging unit is achieved by GPS signal and API of the softwares in the charging unit and in the battery unit of the electric vehicle. This automatic charge location finder eliminates range anxiety for Electric Vehicle drivers and long line at the charging station.

This invention also describes how vehicle ID is associated with users booking information to authenticate for charge to initialize to ensure correct mapping of vehicle to the charge unit. During the charging process, data is collected from the charging unit and other useful information via IoT and into cloud to trigger any necessary action by the charging unit. This methodology herewith includes machine learning and artificial intelligence (AI) to predict charge unit failure or maintenance ahead of time.

Lastly, the payment system is integrated into the mobile app where block chain is used for secured, efficient, transparent payment process.

Currently, there is no prior art that solves multiple problems for high demand for charging electric vehicles. This patent is offering (i) Peer to Peer EV charge sharing solution that solves this demand which also solves range anxiety problem for EV drivers in a seamless charge location finder with seamless payment process and secured charging process that uses encryption and authentication process (ii) Integration with Internet of Things (IoT) in charging infrastructure is offered in this patent. This is useful as the charging unit can communicate directly to the electric vehicle's communication ecosystem for the state of its battery's charging needs and take action accordingly to find the nearest charger and the automated payment process without the intervention from the EV drivers (iii) The invention, further solves charging unit downtime and loss of revenue by doing predictive maintenance so that EV charging station managers can schedule maintenance ahead of time (iv) The usefulness of this invention is further achieved by seamless and automated payment integration for secured, efficient and transparent payment process using the block chain.

### BACKGROUND OF THE INVENTION

The present invention is directed to a methodology of Charge Sharing, Seamless Charging Process and Smart Charging Infrastructure management for Electric Vehicles.

### DESCRIPTION OF THE RELATED ART

Currently there is no cost effective way to meet the high demand for charge needed for electric vehicles. The number of charging station in California is only 3600 where there are 200,000 electric vehicles owners, hence the need for a solution to meet the demand. Range anxiety among Electric Vehicle drivers is one of the common problem along with out of order charging unit at charging stations, incompatible EV charging network card for usage and payment further added to the range anxiety and slower EV adoption.

### SUMMARY OF THE INVENTION

In one embodiment of the present invention, a solution that provides:
1. Peer to peer Electrical Vehicle charging method On Demand.

The other embodiment is for seamless charging process and infrastructure solutions particularly:
2. Finding charging location, authenticating charging usage via electric vehicle to charging unit communication ecosystem & collecting charging unit data using Internet of Things (IoT)
3. Charging usage and charging unit maintenance prediction using Artificial Intelligence and machine learning algorithm in IoT integration
4. Contractless payment integration using Blockchain

### BRIEF DESCRIPTION OF THE DRAWINGS

(Please See Enclosed Drawing File)

FIG. 1 illustrates a block diagram of a preferred embodiment on Peer to Peer Charging Flow

FIG. 2 represents flowchart on how charging unit is integrated with IoT (Internet of Things) to send bi-drectional data, integration of charging unit signal with Electric Vehicle's WiFi or Cellular network for automated charge finder and booking

FIG. 3 represents flowchart of charging unit initialization with vehicle ID information using IoT flow and payment processing using blockchain

### DETAILED DESCRIPTION

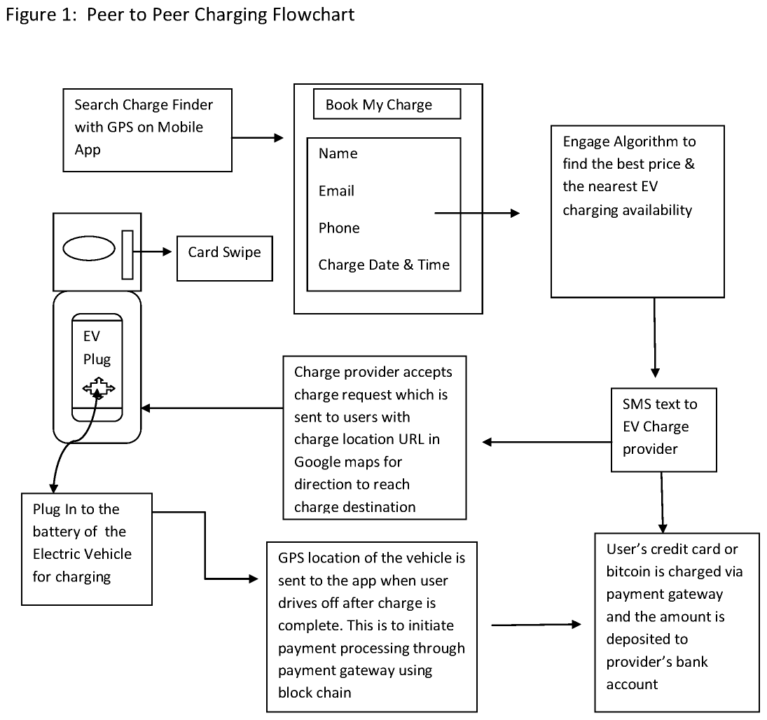

Peer to Peer EV charging Method on Demand: (please refer to FIG. 1 of the enclosed drawing) In this methodology, the demand for electric charge while driving an electric vehicle is solved by peer to peer charge sharing in real time. User access the service via a mobile app which uses GPS location to display the nearest available Electric Vehicle Charge and the Type of Charge provided.

User then selects the location to send a charging, request. The charging request notification is sent via SMS text message to the provider who has the option to either accept or reject the charging request.

If the Charge Provider rejects, then the programming algorithm is used to find the next Charge Provider until the Charging request is accepted.

Once a Provider accepts the Charging request, User is then notified via text message with the charge location address which has a link to GPS based location map. Upon arrival at the Charge location, User connects the cable provided by the Charge Provider onto their electric vehicle socket for electric charge to begin. The time and the coordinate is recorded in a temporary server for billing purpose. As soon as the User is done with charging their electric vehicle, the amount is calculated by the kilowatt of energy and the total amount is charged in dollars to User's credit card or by blockcharge using blockchain payment integration with secured payment gateway that is integrated into the mobile app. A certain percentage of the amount charged is automatically deposited to Charge Providers' account to complete the charge sharing process.

Charge Location Finder:

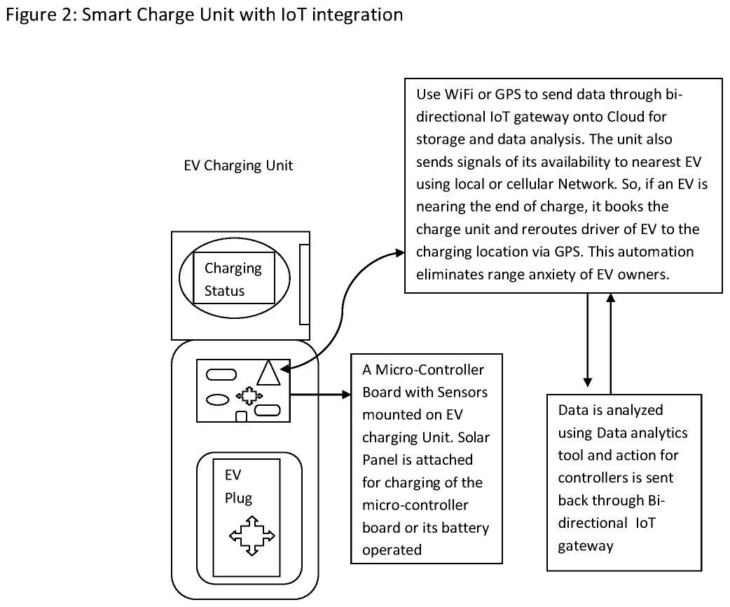

(Please Refer to FIG. 2 of the Enclosed Drawing)

The charge location finder is further enhanced via satellite GPS or WiFi or Bluetooth, depending on the location of the vehicle to the charging unit. The availability is noted on the mobile app when the signal is sent via WiFi or GPS that a charge unit is available. This is achieved by adding sensors and a WiFi enabled micro-controller (such as Raspberry Pi) mounted on the charging unit.

The Bluetooth device has embedded chipset that transmits range of 100 meter, the range is amplified further by placing the Bluetooth in a mesh design among different EV charge units. The signal from the charge unit (GPS or WiFi or Bluetooth) interacts with the signal of the Electric vehicle, it negotiates the best price among other charging stations by an automated pricing mechanism that uses a pre-defined price threshold set by the charge providers and rules algorithm that is applied dynamically in real time integrated into the mobile app. It also checks for availability for the nearest charging location so user don't have to wait in line to get their vehicle charged and it directs user to those locations via Google map.

Price and Availability of the Charging Unit:

(Please Refer to FIG. 2 of the Enclosed Drawing)

To add further seamless integration, the sensors in the charging unit sends the signal of its availability and pricing via microcontroller board automatically with the electric vehicle's charging unit so when charge in the electric vehicle reaches a certain threshold, it engages the charge locater app and connects with the nearest charging unit for the available best price for the EV owner and uses google map to the charge unit location to charge the EV.

Smart Charge Infrastructure with IoT: Authenticating Charge Usage and Data Collection:

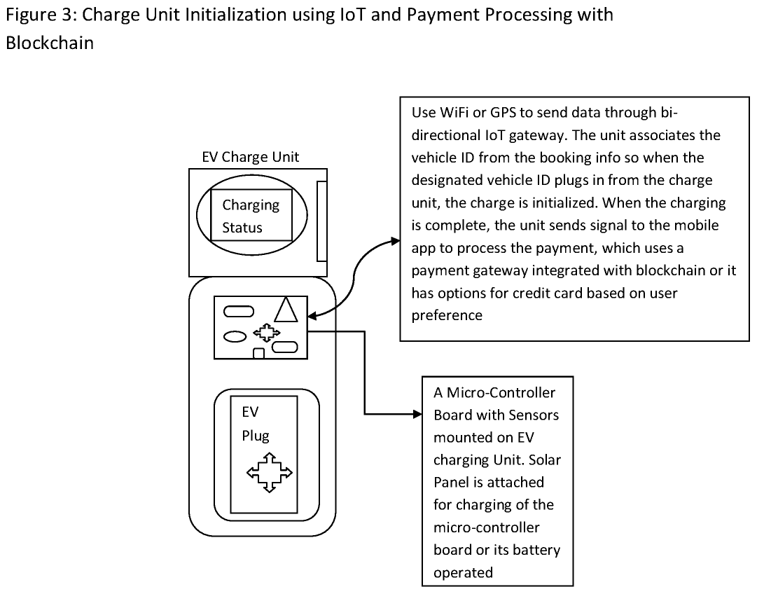

(Please Refer to FIGS. 2 and 3 of the Enclosed Drawing)

In a smart EV charging system, the required tasks that controller of a charging unit performs are: track users, queue charging, take payment, track power consumption, allocate resources, etc. The implementation of a smart EV charging system requires user sign up through a mobile app, selects their vehicle ID and the charging port the vehicle will plug into at the charging station so that the charging unit can send that information to the central server via cloud and back to the controller at the charging port to initialize the charge sequence.

This is achieved using IoT flow which is essentially a microcontroller board such as Raspberry Pi alongside embedded sensors in the charging unit that collects charging data and uses IoT Gateway to send the data over Cloud via GPS or WiFi. The charge sequence and queuing will depend on the algorithms implemented in the server. The battery state of charge is also obtained via micro-controller board with sensors in the charging unit and the data is sent over the cloud to the central server for data analysis.

Charge Usage Predictability Using Machine Learning and AI:

Data collected by the IoT flow which is using a micro-controller board and sensors and sending data using GPS or WiFi are analyzed. Some of the data collected are: state of charge of the battery data, charge usage pattern with respect to vehicle type, environmental health of the charging unit, etc. These data are trained using machine learning and AI time series prediction model. This model generates predictability of the Charge Usage demand in a Charging infrastructure. The model can also generate information as to the optimal dynamic scheduling of the charging units which in turn saves money for charging infrastructure management.

The data generated from the AI model is also useful for wider grid stabilization. The dynamic scheduling of EV charging can be done using the IoT flow to turn on or off the charging sequence via micro-controller remotely. The environment health data of the charging unit can be used for preventive maintenance. The performance of the charging unit is fed into the AI model, which can predict maintenance failures ahead of time and schedule maintenance accordingly.

Payment Integration Using Block Chain

(Please Refer to FIG. 3 of the Enclosed Drawing):

By using an IoT gateway client software at the charging pole which establishes direct connection to the ethereum blockchain in the back-end via GPS or WiFi and uses a smart phone app to communicate with the payment interface. When EV charge is initialized, the payment gateway is accessed and it gets processed when the charge is complete. The blockchain can manage and record all of the payment and charging data, a fully automated authentication ledger system which gives a solution for charging and billing without centralized system or middle man.

This makes EV charging payment process very easy, efficient, secured and transparent for EV owners, EV charging station managers and it is specially applicable for peer to peer EV charging network. This solution enables Electric Vehicles to be in blockchain system through smart contracts to automatically pay the charging station thus making it more efficient. It sets the stage for machine to machine autonomously exchanging service and value.

Claims

The invention herewith . . .
(a) The invention is a solution to meet charging demand for electric vehicles. It solves this demand by providing a peer to peer charging solution in real time using GPS location with a smartphone app interface that uses integrated online payment gateway. claim (a) further characterized in that, peer to peer EV charge sharing on demand using GPS location and app interface in real time is not captured in prior art nor integrated automated payment solution using blockchain in this type of application platform.
(b) The said invention in claim (b) comprised of a real time monitoring of charge usage for

1. (a) The invention is a solution to meet charging demand for electric vehicles. It solves this demand by providing a peer to peer charging solution in real time using GPS location with a smartphone app interface that uses integrated online payment gateway.
Claim (a) further characterized in that, peer to peer EV charge sharing on demand using GPS location and app interface in real time is not captured in prior art nor integrated automated payment solution using blockchain in this type of application platform. The said invention is further applicable for charging location finder via satellite GPS or WiFi or Bluetooth depending on the location of the vehicle with respect to the charging unit. The availability is noted on the mobile app when the signal from the charging unit is sent via WiFi or GPS that a charging unit is available nearby using a parking sensor on the ground or on a pole or Bluetooth enabled lock attached to the electric vehicle charging unit.
(b) said invention in claim 1 (a) covers diverse applications. The said invention is applicable for parking sharing among peers with a parking sensor connected to the internet via WiFi or LoRaWAN IoT gateway.
The applications for the said invention is for peer to peer residential usage, small business owners, retail owners, hotels, resorts, vacation home renters, hospitals, provider of parking lots in the city, apartment buildings for city dwellers who would not have their own Electric Vehicle charging units, etc.

2. (a) The said invention is further enhanced for automatic finding of EV charge finder from the Electric Vehicle itself. In charging station, it uses sensors in the charging unit which sends the signal of its availability and pricing via micro-controller board to the nearest Electric Vehicle's communication ecosystem (WiFi or GPS network) so that when charge in the Electric Vehicle's battery reaches a certain threshold, it engages the charge locater app in the EV's dashboard screen display and connects to the nearest charging unit. It then utilizes the automated real time pricing model which has a pre-defined price threshold built into its algorithm. So, it can automatically negotiate the best price for the customers.
The said invention in claim 2 (a) is applicable for Smart Charging Infrastructure where it seamlessly captures Data Collection of the Charging Unit using IoT (Internet of Things). It uses sensors and micro-controller board to send data such as charge usage, charge unit idle time, charge unit performance, environmental data, vehicle data, etc. using WiFi or GPS to the cloud where data analytics are performed on the collected data and then certain actions are triggered at the charging unit based on the collected data. Charge Usage is modeled based on running Machine Learning algorithm and Artificial Intelligence model to generate predictive analytics of usage model. The model generates information as to the optimal dynamic scheduling of the charging units and the environment health data of the charging unit can be fed into the AI model to predict maintenance failure ahead of time and schedule maintenance accordingly and alert the maintenance personnel ahead of time to minimize charging unit downtime.
The said invention of a smart EV charging system integrated with IoT is further applicable to a method of charge user authentication. The method is implemented that the charging user signs up through a mobile app, selects their vehicle ID and the charging port the vehicle will plug into at the charging station so that the charging unit can send that information to the central server via cloud and back to the controller at the charging port to initialize the charge sequence.

3. The said invention is further applicable to payment Integration using Block Chain. By using an IoT gateway client software at the charging unit which establishes direct connection to the ethereum blockchain in the back-end via GPS or WiFi and uses a mobile app to communicate with the payment interface.
This payment process using blockchain can manage and record all of the payment and charging data which is a fully automated authentication ledger system for efficient, secured and transparent for EV owners, EV station managers and peer to peer EV charging network.
